(19) United States
(12) Patent Application Publication
(10) Pub. No.: US 2023/0299986 A1
(43) Pub. Date: Sep. 21, 2023

(54) SYSTEM AND DEVICE FOR CONTROL OF POWER OVER COAX FOR ETHERNET AND POWER OVER ETHERNET DEVICES

(71) Applicant: PPC BROADBAND, INC., East Syracuse, NY (US)

(72) Inventors: Thomas HART, Fayetteville, NY (US); David BARANY, Syracuse, NY (US)

(73) Assignee: PPC BROADBAND, INC., East Syracuse, NY (US)

(21) Appl. No.: 18/122,437

(22) Filed: Mar. 16, 2023

Related U.S. Application Data
(60) Provisional application No. 63/320,626, filed on Mar. 16, 2022.

(51) Int. Cl. H04L 12/10

(52) U.S. Cl. CPC H04L 12/10

(57) ABSTRACT

A power-over-Ethernet (“PoE”) controller for selectively controlling supply of a composite Ethernet/DC power signal to a PoE device. The PoE controller may include a control device that may be configured to generate control signals, wherein the control signals may be configured to selectively control supply and non-supply of a composite Ethernet/DC power signal to a PoE device based on the control signals and DC power and Ethernet signals supplied over a coaxial cable so as to enable or dis-enable operation of the PoE device, wherein the PoE device may be configured to receive the composite Ethernet/DC power signal at an Ethernet input port, and wherein the DC power signal may be configured to power operation of the PoE device.

### BACKGROUND

### Cross-Reference to Related Application

This application claims priority to US Provisional Patent Application No. 63/320,626, filed Mar. 16, 2022, the disclosure of which is incorporated herein by reference in its entirety.

### Background

The present invention relates generally to a controller device and system for controlling application of power to remote devices. More particularly, the present invention relates to a PoE controller and system configured to provide remote control of power over one or more coaxial cables for remote Ethernet and/or power-over-Ethernet (PoE) devices.

Many cable television and other service providers provide service to customers over coaxial cables. The coaxial cables may be connected to a customer premises equipment, such as a modem or cable television box, so that the signals sent over the coaxial cables may be provided to a television and/or other devices. In some instances, the signals may be directed to multiple devices, such as television(s), a modem, one or more wireless access points, a WIFI extender, Internet Protocol Cameras, etc.

The coaxial cable providing the data signals from the service provider may be connected to a device such as a modem. The modem or other device may include outputs to provide data and control signals to the other devices over an Ethernet cable, for example. However, in some instances, the other devices connected to the modem by the Ethernet cables may be at various locations within or outside of a location or residence. Some of these locations may be disposed where it may be difficult to provide power to the other devices, such as when power outlets are not available at the location where the device is located. Additionally, many locations are wired with coaxial cabling and not Ethernet cabling. For example, a location may have been prewired with coaxial wall jacks with coaxial wiring connecting to the coaxial wall jacks, but not have Ethernet wall jacks connected with Ethernet wiring. Accordingly, it would be beneficial if PoE devices configured to accept Ethernet signals at an Ethernet input could be provided power and Ethernet signals over the existing coaxial cabling because this would avoid the need to install separate Ethernet wiring. Instead, existing coaxial wiring could be used to provide Ethernet signals and power to PoE devices using the existing coaxial wall jacks and coaxial cabling. It would also be beneficial if a provider of the Ethernet signals could selectively control whether to apply or not apply the power and Ethernet signals to the PoE devices.

Accordingly, it may be desirable to provide a device or system that provides power over the coaxial cable along with the data and/or control signals. It may further be desirable to provide a device or system that provides power to a PoE device over the Ethernet cables, in addition to providing data and/or control signals, so as to permit enabling and disabling of the PoE device.

### SUMMARY

In accordance with various embodiments of the present disclosure, a power-over-Ethernet (“PoE”) controller is configured for selectively controlling supply of a composite Ethernet/DC power signal to a PoE device. The PoE controller may include a control device that may be configured to generate control signals, a power supply that may be configured to supply a DC power signal, and/or a selection device that may be configured to receive the control signals and the DC power signal and to selectively provide and/or not provide the DC power signal to an Ethernet PoE device. The Ethernet PoE device may be configured to generate a composite Ethernet/DC power signal upon receiving the DC power signal and an Ethernet signal via a coaxial input port and to output the composite Ethernet/DC power signal to a PoE device via an Ethernet output port. The control device may be configured to be disposed outside a residential unit. The PoE device may be configured to be disposed within the residential unit. The PoE device may be configured to receive the composite Ethernet/DC power signal at an Ethernet input port. The DC power signal may be configured to power the PoE device, and the control device may be configured to selectively control supply and non-supply of the Ethernet/DC power signal to the PoE device based on the control signals so as to permit enabling and disabling of the PoE device.

In accordance with various embodiments of the present disclosure, a power-over-Ethernet (“PoE”) controller is configured for selectively controlling supplying of a composite Ethernet/DC power signal to a PoE device. The PoE controller may include a control device that may be configured to generate control signals, a selection device that may be configured to receive the control signals and a DC power signal and to selectively provide and not provide the DC power signal to an Ethernet PoE device, wherein the Ethernet PoE device may be configured to generate a composite Ethernet/DC power signal upon receiving the DC power signal and an Ethernet signal via a coaxial input port and to output the composite Ethernet/DC power signal to a PoE device via an Ethernet output port, wherein the PoE device may be configured to receive the composite Ethernet/DC power signal at an Ethernet input port, wherein the DC power signal may be configured to power the PoE device, and wherein the control device may be configured to selectively control supply and non-supply of the Ethernet/DC power signal to the PoE device based on the control signals so as to permit enabling and disabling of the PoE device.

In accordance with various embodiments of the present disclosure, a power-over-Ethernet (“PoE”) controller is configured for selectively controlling supply of a composite Ethernet/DC power signal to a PoE device. The PoE controller may include a control device that may be configured to generate control signals, wherein the control signals may be configured to selectively control supply and non-supply of a composite Ethernet/DC power signal to a PoE device based on the control signals and DC power and Ethernet signals supplied over a coaxial cable so as to permit enabling and disabling of the PoE device, wherein the PoE device may be configured to receive the composite Ethernet/DC power signal at an Ethernet input port, and wherein the DC power signal may be configured to power the PoE device.

Various aspects of the, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a schematic view of a system in accordance with disclosed aspects.

FIG. 2 is schematic views of a control device in accordance with disclosed aspects.

FIG. 3 is a schematic view of a system in accordance with disclosed aspects.

FIG. 4 is a schematic view of a system in accordance with disclosed aspects.

### DETAILED DESCRIPTION OF EMBODIMENTS

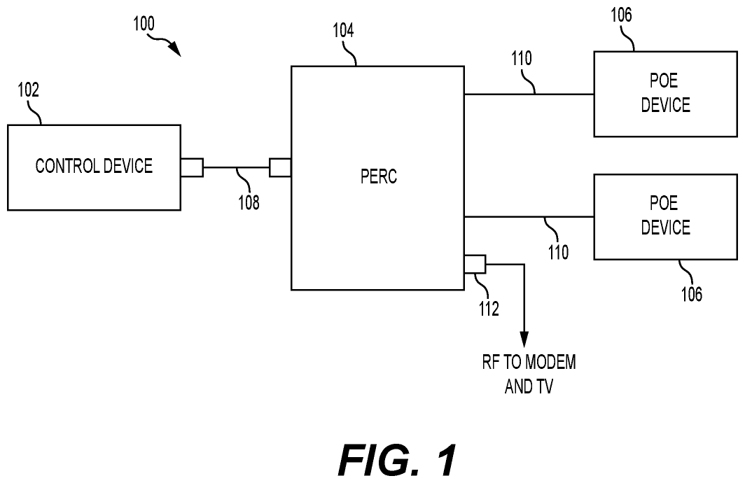

Referring first to FIG. 1, a system 100 according to various embodiments is depicted. The system 100 is configured to selectively provide power-over-coaxial via a coaxial cable and then to provide power-over-Ethernet via an Ethernet cable to one or more PoE (Power-Over-Ethernet) devices. The system 100 may include a control device 102 and a PERC RF PoE injector device 104 (PERC, also referred to as an Ethernet PoE device) configured to selectively provide power and data signals to the one or more PoE devices 106. The control device 102 and a PERC RF PoE injector device 104 (PERC) may in combination be a controller device that is configured selectively provide power and data signals to the one or more PoE devices 106.

In various embodiments, the control device 102 is configured to provide power, Ethernet and cable tv signals to the PERC 104. In some embodiments, the control device 102 may be connected to the PERC 104 by a coaxial cable 108, for example. The control device 102 may provide the power, Ethernet and data signal such as cable tv or other signals to the PERC 104 over the coaxial cable 108, for example.

In various embodiments, the PERC 104 may be connected to the one or more PoE devices 106. The PERC 104 may be configured to provide the Ethernet signals and power to the POE device(s) 106 over an Ethernet cable 110, for example.

In some embodiments, the control device 102 is configured to selectively supply and stop supplying power to both the PERC 104 and the PoE device(s) 106. In some embodiments, the control device 102 may be remotely located from both the PERC 104 and the PoE device(s) 106. In some embodiments, the PERC 104 and the PoE device(s) 106 may be located in a customer premises, such as an apartment or other residential unit, and the control device 102 may be located outside the customer premises. Additionally, the control device 102 may be under the control of a service provider, such as a cable television provider and/or an Internet Service Provider, for example. The control device 102 is configured to selectively provide the power to both the PERC 104 and to the one or more PoE device(s) 106. Thus, the control device 102 may selectively supply power and selectively terminate supply of power to both the PERC 104 and to the one or more PoE device(s) 106. The service provider may be able to selectively supply or not supply the power and/or data signals to both the PERC 104 and to the one or more PoE device(s) 106 by utilizing the control device 102. For example, if the user of the PoE device(s) 106 fails to pay for services provided by the service provider or for other reasons, the service provider may choose to terminate supply of power and/or data signals to the PERC 104 and the PoE device(s) 106.

In some embodiments, the PERC 104 may also have a standard coaxial or other output(s) 112 for outputting data signals (such as Ethernet signals) to non-PoE devices, such as a modem.

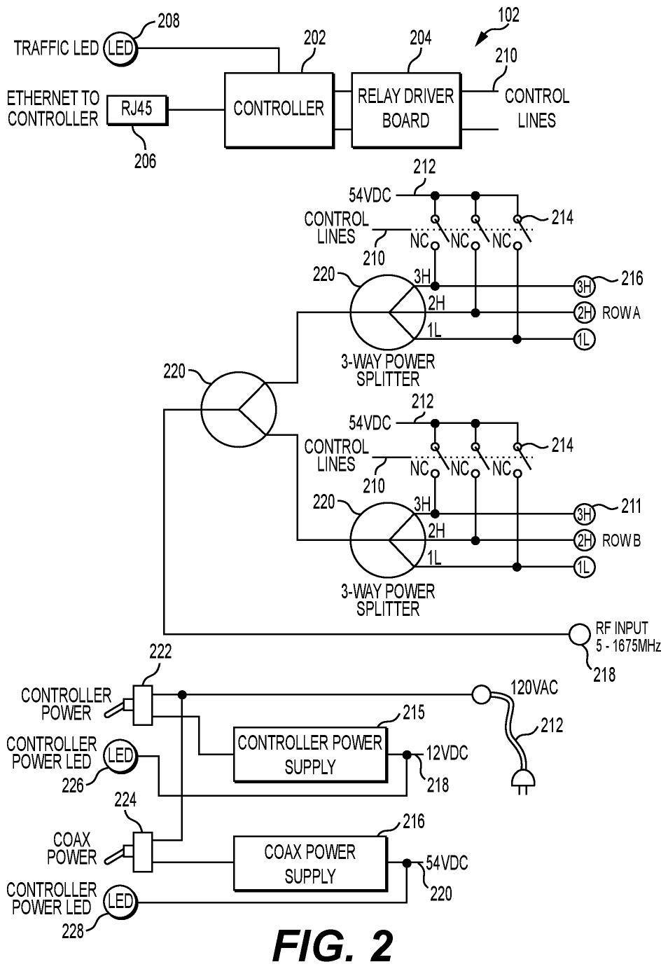

As illustrated in FIG. 2, in some embodiments the control device 102 may include a controller 202 and a relay driver board 204. The control device 102 may be configured to selectively control power signals and/or data signals supplied to one or more PoE devices 106 in a single residential unit, or to selectively control power and/or data signals supplied to one or more PoE devices 106 in a plurality of residential units. For example, the controller 102 may be configured to selectively control power and/or data signals supplied to one or more PoE devices 106 in a plurality of apartments. In such a configuration, the control device 102 may be configured to be located outside of the apartments, such as in a utility room. The control device 102 may be configured to selectively supply power and/or data signals or to cut the supply of power and/or data signals to the PERC 104 and the PoE devices 106 in each of the apartment units. This configuration allows a service provider having control of the control device 102 to selectively supply or cut supply of power and/or data signals to the PERC 104 and the PoE devices 106, allowing resetting of the devices with a power cycle or termination of the power and/or data signals in situations such as where a customer does not pay their bill or for other reasons.

The controller 202 may be a conventional controller such as a microprocessor and may have associated programming stored in a memory (not shown). The programming may be utilized by the controller 202 to perform the functionality described herein, for example. The controller 202 may receive incoming signals over an Ethernet connection 206, for example. In some embodiments, a traffic LED 208 may be utilized to indicate traffic flowing through the controller 202. The controller 202 in conjunction with the relay driver board 204 may be configured to output control signals on control lines 210.

In some embodiments, the control device 102 may include a controller power supply 215 and a coaxial power supply 216. The controller power supply 215 and the coaxial power supply 216 may both receive power from a 120 VAC supply 212, for example, although other power sources could be used, such as a 54 VAC supply.

In some embodiments, the controller power supply 215 may be configured to output 12 VDC on output line 218. In some embodiments, the coaxial power supply 216 may be configured to output 54 VDC on output line 220. In some embodiments, a controller power switch 222 may be utilized allowing the 120 VAC power to the controller power supply 215 to be shut on or off. In some embodiments, a coaxial power supply switch 224 may be utilized allowing the 120 VAC power to the coaxial power supply 216 to be shut on or off.

In some embodiments, a controller power LED 226 may be utilized to present a visual indication of when the controller power supply 215 is supplying power. In some embodiments, a coaxial power LED 228 may be utilized to present a visual indication of when power is supplied by the coax power supply 216.

In some embodiments, the control device 102 is configured to control power supplied to one or more PoE devices 106. For example, the control signals output from the relay driver board 204 may be input to switches 214, which receive power at power input 212. The relay driver board 204 and the switches 214 may comprise a selection device. The control signals selectively open and close the switches 214, to selectively apply the power on output lines 216. In some embodiments, the power supplied may be 54 VDC, although other power levels could be used.

Additionally, RF signals may be input on RF input 218, which may be configured to use signals in a frequency range of 5-1675 MHz, although other frequency range signals could be used. These RF signals may be received from a cable television system or other service provider system or source, for example.

In some embodiments, the RF signals may be split by one or more splitters 220 to be supplied to different residential units. After the RF signals are split, the RF signals may be combined with power signals output from the switches 214.

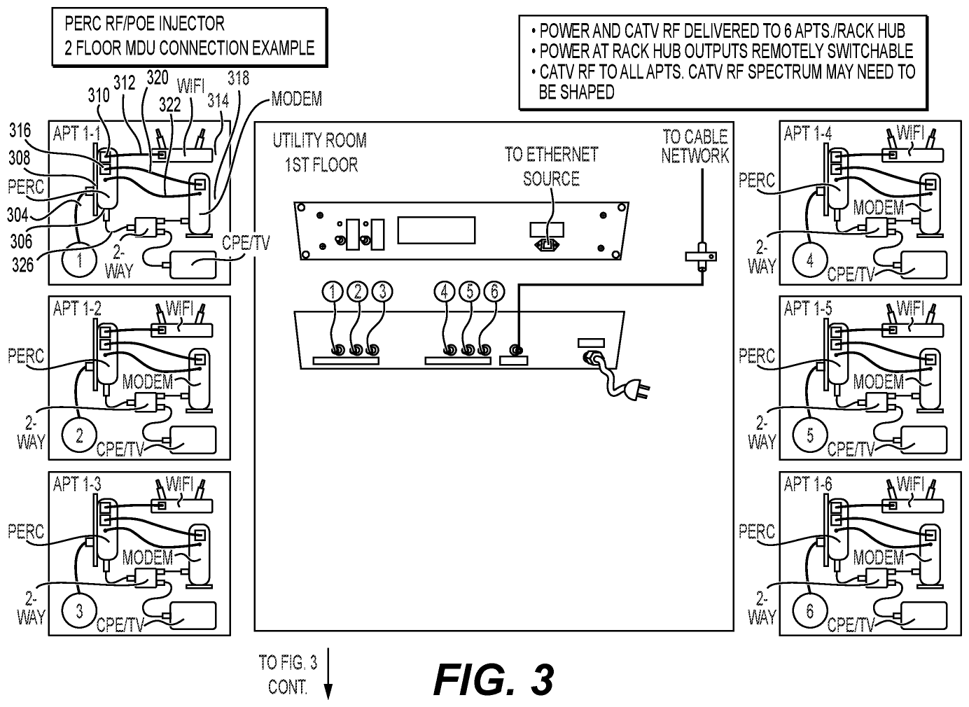

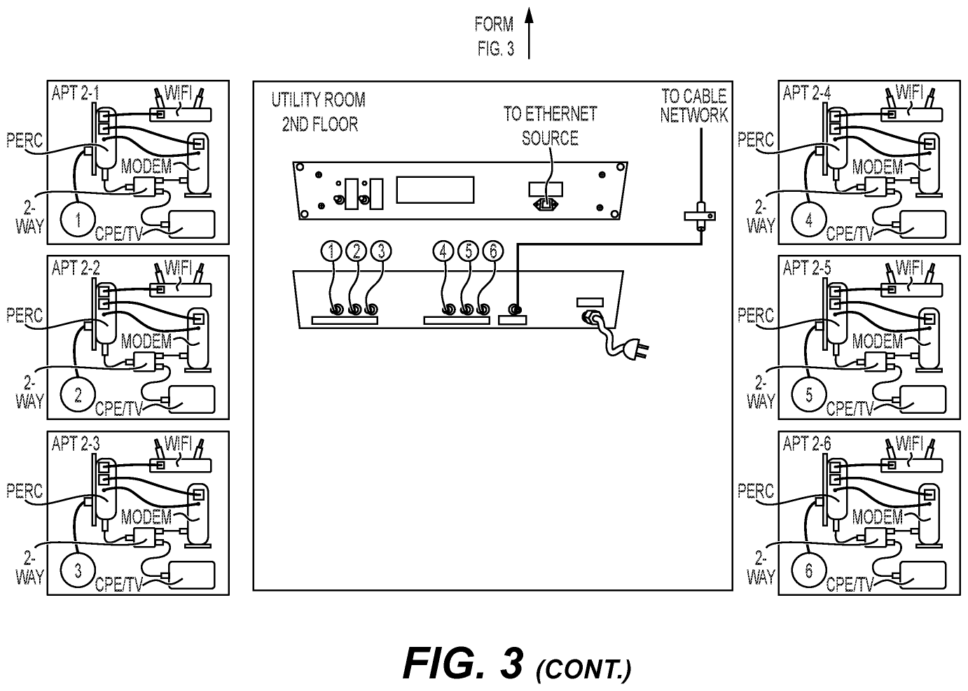

The embodiments illustrated in FIG. 3 shows how the system 100 may be utilized to supply power, Ethernet signals and/or cable tv signals over coaxial to the PERC and how the PERC can then supply power and Ethernet signals over Ethernet cable(s) to one or more PoE device in a plurality of subscriber locations, such as apartment units. The control device 302 may be located in a utility room, for example, and may be disposed outside of the apartment units. The control device 302 may selectively supply the DC power to the PERC 306 as previously described, over coaxial cables 304, along with Ethernet and cable TV signals.

In some embodiments, the PERC 306 has a coaxial connector 308 to receive the signals over the coaxial cable 304. The PERC 306 may include an Ethernet output 310. An Ethernet cable 312 may be connected to the Ethernet output at one end and the other end of the Ethernet cable 312 may be connected to an Ethernet input of PoE device 314. The PERC 306 outputs the power and Ethernet signals to the PoE device 314 under the condition that the controller 302 has supplied the power and Ethernet signals to the PERC 306. The POE device 314 thus does not have to be directly connected to power, since it can receive power over the Ethernet connection. This allows the PoE device 314 to be disposed at locations where a power outlet may not be located.

The PERC 306 may also have another Ethernet output 316 which does not output power, that may be connected to another device, such as modem 318 with Ethernet cable 320. The modem 318 may be directly connected to a power source or be connected to a power output of the PERC 306 with power cable 322. The control device 302 may receive RF signals on input 324. The PERC 306 may also have a standard coaxial output 326 for connecting to the modem 318 and/or other devices.

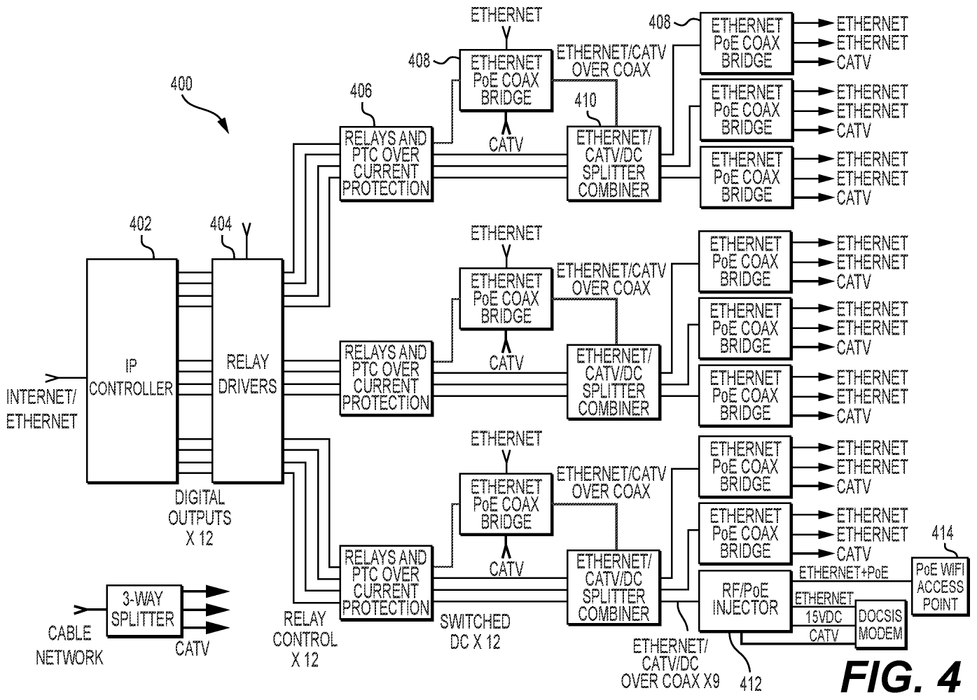

FIG. 4 discloses a system 400 in accordance with various embodiments. The system 400 is configured to provide selective control of the application of power for PoE (power-over-Ethernet) devices and other devices. The system 400 includes controller 402 that receives Internet/Ethernet signals and generates control signals for generating signals for relay drivers 404. FIG. 4 illustrates 12 control signals, although any number of control signals could be utilized. Additionally, while one controller 402 is illustrated, any number of controllers could be utilized.

The relay drivers 404 generate driving signals to drive the relays and PTC overcurrent protection circuits 406 to provide current overprotection as needed. FIG. 4 illustrates relay drivers 404 with 12 outputs, although any number of outputs may be used. Additionally, multiple relay drivers 404 could be used in some embodiments.

The Ethernet PoE coax bridges 408 receive Ethernet and Cable TV signals and combine the signals to output Ethernet/cable tv over coax signals. The Ethernet/CATV/DC splitter combiner 410 combines the Ethernet/CATV signals with DC power. The Ethernet PoE coax bridges 408 can supply Ethernet and CATV signals. When power-over-Ethernet is needed for PoE devices, the system can include the RF/PoE injector 412 that receives Ethernet/CATV/DC power over coaxial as previously described.

The RF/POE injector 412 outputs Ethernet signals and power-over-Ethernet over an Ethernet cable to one or more PoE device, such as wireless access point 414. In some embodiments, the RF/PoE injector 412 can separately output Ethernet, CATV and power to other non-PoE devices, such as a modem 416, television, or other device.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A power-over-Ethernet (“PoE”) controller for selectively controlling supply of a composite Ethernet/DC power signal to a PoE device, comprising:
a control device configured to generate control signals;
a power supply configured to supply a DC power signal;
a selection device configured to receive the control signals and the DC power signal and to selectively provide and not provide the DC power signal to an Ethernet PoE device;
wherein the Ethernet PoE device is configured to generate a composite Ethernet/DC power signal upon receiving the DC power signal and an Ethernet signal via a coaxial input port and to output the composite Ethernet/DC power signal to a PoE device via an Ethernet output port;
wherein the control device is configured to be disposed outside a residential unit;
wherein the PoE device is configured to be disposed within the residential unit;
wherein the PoE device is configured to receive the composite Ethernet/DC power signal at an Ethernet input port;
wherein the DC power signal is configured to power the PoE device; and
wherein the control device is configured to selectively control supply and non-supply of the Ethernet/DC power signal to the PoE device based on the control signals so as to permit enabling and disabling of the PoE device.

2. The PoE controller of claim 1, wherein the selection device comprises a relay driver and a switch device, and wherein the relay driver is configured to generate relay signals to drive the switch to selectively apply and not apply the DC power signal to the Ethernet PoE device.

3. The PoE controller of claim 1, wherein the PoE device comprises a plurality of PoE devices.

4. The PoE controller of claim 3, wherein the control device is configured to selectively control supply and non-supply of the composite Ethernet/DC power signal to each of the PoE devices.

5. The PoE controller of claim 3, wherein the PoE devices are located in a plurality of residential units, and the control device is configured to selectively control supply and non-supply of the composite Ethernet/DC power signal to each of the POE devices in each of the residential units.

6. The PoE controller of claim 3, wherein the control device comprises a relay driver configured to drive a plurality of relays to selectively control supply and non-supply of the composite Ethernet/DC power signal to each of the PoE devices.

7. The PoE controller of claim 3, wherein the Ethernet PoE device comprises a non-PoE Ethernet output port configured to output an Ethernet signal without DC power to a non-PoE device.

8. A power-over-Ethernet (“PoE”) controller for selectively controlling supply of a composite Ethernet/DC power signal to a PoE device, comprising:
a control device configured to generate control signals;
a selection device configured to receive the control signals and a DC power signal and to selectively provide and not provide the DC power signal to an Ethernet PoE device;
wherein the Ethernet PoE device is configured to generate a composite Ethernet/DC power signal upon receiving the DC power signal and an Ethernet signal via a coaxial input port and to output the composite Ethernet/DC power signal to a PoE device via an Ethernet output port;
wherein the PoE device is configured to receive the composite Ethernet/DC power signal at an Ethernet input port;
wherein the DC power signal is configured to power the PoE device; and
wherein the control device is configured to selectively control supply and non-supply of the Ethernet/DC power signal to the PoE device based on the control signals so as to permit enabling and disabling of the PoE device.

9. The PoE controller of claim 8, wherein the selection device comprises a relay driver and a switch device, and wherein the relay driver is configured to generate relay signals to drive the switch to selectively apply and not apply the DC power signal to the Ethernet PoE device.

10. The PoE controller of claim 8, wherein the PoE device comprises a plurality of PoE devices.

11. The PoE controller of claim 10, wherein the control device is configured to selectively control supply and non-supply of the composite Ethernet/DC power signal to each of the PoE devices.

12. The PoE controller of claim 10, wherein the PoE devices are located in a plurality of residential units, and wherein the control device is configured to selectively control supply and non-supply of the composite Ethernet/DC power signal to each of the POE devices in each of the residential units.

13. The PoE controller of claim 10, wherein the control device comprises a relay driver configured to drive a plurality of relays to selectively control supply and non-supply of the composite Ethernet/DC power signal to each of the PoE devices.

14. The PoE controller of claim 10, wherein the Ethernet PoE device comprises a non-PoE Ethernet output port configured to output an Ethernet signal without DC power to a non-PoE device.

15. A power-over-Ethernet (“PoE”) controller for selectively controlling supply of a composite Ethernet/DC power signal to a PoE device, comprising:
a control device configured to generate control signals;
wherein the control signals are configured to selectively control supply and non-supply of a composite Ethernet/DC power signal to a PoE device based on the control signals and DC power and Ethernet signals supplied over a coaxial cable so as to enable or dis-enable operation of the PoE device;
wherein the PoE device is configured to receive the composite Ethernet/DC power signal at an Ethernet input port; and
wherein the DC power signal is configured to power operation of the PoE device.

16. The PoE controller of claim 15, further comprising a power supply configured to supply the DC power signal.

17. The PoE controller of claim 16, further comprising a selection device configured to receive the control signals and the DC power signal and to selectively provide and not provide the DC power signal to an Ethernet PoE device, wherein the Ethernet PoE device is configured to generate a composite Ethernet/DC power signal upon receiving the DC power signal and an Ethernet signal via a coaxial input port and to output the composite Ethernet/DC power signal to the PoE device via an Ethernet output port.

18. The PoE controller of claim 17, wherein the selection device comprises a relay driver and a switch device, and wherein the relay driver is configured to generate relay signals to drive the switch device to selectively apply and not apply the DC power signal to the Ethernet PoE device.

19. The PoE controller of claim 17, wherein the PoE device comprises a plurality of PoE devices.

20. The PoE controller of claim 19, wherein the control device is configured to selectively control supply and non-supply of the composite Ethernet/DC power signal to each of the PoE devices.

21. The PoE controller of claim 19, wherein the PoE devices are located in a plurality of residential units, and wherein the control device is configured to selectively control supply and non-supply of the composite Ethernet/DC power signal to each of the POE devices in each of the residential units.

22. The PoE controller of claim 19, wherein the control device comprises a relay driver configured to drive a plurality of relays to selectively control supply and non-supply of the composite Ethernet/DC power signal to each of the PoE devices.

23. The PoE controller of claim 19, wherein the Ethernet PoE device comprises a non-PoE Ethernet output port configured to output an Ethernet signal without DC power to a non-PoE device.
